(19) United States
(12) Patent Application Publication
(10) Pub. No.: US 2012/0013981 A1
(43) Pub. Date: Jan. 19, 2012

(54) PHOTOCHROMIC OPTICAL ELEMENTS

(75) Inventors: Pasquale Matera, Plainview, NY (US); David Kessler, Rochester, NY (US)

(73) Assignee: SOL-GRID, LLC, Rochester, NY (US)

(21) Appl. No.: 13/185,208

(22) Filed: Jul. 18, 2011

Related U.S. Application Data
(60) Provisional application No. 61/365,544, filed on Jul. 19, 2010.

(51) Int. Cl. G02B 5/30

(52) U.S. Cl. 359/485.05

(57) ABSTRACT

An optical element has a substrate material having a pattern of cavities formed on a surface and a substantially transparent seal layer disposed against the surface. A photochromic or electrochromic material is sealed by the substantially transparent seal layer within the cavities formed in the surface.

### CROSS-REFERENCE TO RELATED APPLICATIONS

The present application claims the benefit under 35 U.S.C. §119(e) of U.S. Provisional patent application No. 61/365,544 filed on Jul. 19, 2010 and entitled “Photochromic, electrochromic, and polarized applications on curved surfaces, lenses, domes, flat panels, and LCD displays” by Matera et al., the entire disclosure of which is incorporated by reference herein.

### FIELD

The present invention relates to light-responsive optical elements and more particularly relates to optical elements formed with electrochromic materials.

### BACKGROUND

Photochromic and related electrochromic materials, used in so called color changing eyewear and sunglasses, change from being optically transparent to opaque upon exposure to sufficient light or electrical energy. Light-responsive photochromic lenses darken on exposure to UV/photonic radiation. After the radiation is removed (for example by moving indoors), the lenses gradually return to their clear state.

Photochromic lenses are made from many different materials including glass, plastic, or polycarbonate. There are many types of photochromic materials in various classes: triarylmethanes, stilbenes, azastilbenes, nitrones, fulgides, spiropyrans, naphthopyrans, spiro-oxazines, quinones among others. Glass substrates are conventionally treated to provide this property by embedding microcrystalline silver halides (typically silver chloride), within the glass. Plastic and resin photochromic lenses rely on organic photochromic molecules such as oxazines and naphthopyrans to achieve reversible opacity. Photochromic lenses typically darken in sunlight, but not under artificial light since the photochromic dyes used are UV (ultraviolet) light sensitive. Automobile windows and glass naturally block UV light to some degree, which lowers the amount the lenses will darken. Recently, new dyes have been developed that allow the lenses to darken in response to visible light.

In order to embed the dye in lens materials, the lens is typically heated, opening pores in the surface which allows the dye to be deposited. These pores are, by their nature, random in depth, size and placement. Uniform concentration of the dye is not achieved so that the lens is not optimized in performance. Deposited generally on the surface of the product, the applied dyes can easily be worn away from the lens surface or damaged by chemicals or abrasion, for example. This is even true when a coating is applied. This shortcoming of conventional fabrication necessitates improved methods for forming photochromic optical elements.

When photochromic materials are dispersed in a glass substrate, the amount of darkening or density depends on the thickness of glass. This poses problems in photochromic response with variable-thickness prescription lenses. In plastic and resin lenses, the photochromic material is typically embedded into the surface layer of the plastic in a uniform thickness of up to 150 μm and material response is somewhat faster.

With exposure to UV light, the typical commercial photochromic lens darkens or achieves greater density over a period of approximately fifteen minutes, with the bulk of the transformation occurring within less than one minute. Lenses revert to a clear state within a similar time frame as soon as they are removed from UV light exposure. Research indicates that even in dark conditions, photochromic lenses can absorb up to 20% of ambient light.

Temperature can have a significant effect on photochromic materials. Because photochromic compounds fade to a clear state by a thermal process, the higher the temperature, the less the available density range. This temperature dependency prevents photochromic devices from achieving total or near total density at high ambient temperatures. Conversely, photochromic lenses turn very dark in cold temperatures. For this reason, photochromic lenses have been limited to eyewear and devices wherein the transformation from dark to light is restricted to a relatively narrow range.

At a more molecular level, the switching speed of photochromic dyes appears to be highly sensitive to the rigidity of the environment around the dye. As a result, these dyes switch more rapidly in solution or “loose” environment and more slowly in a rigid environment, such as when they are embedded in a polymer or glass lens. Recently, it has been discovered that by attaching flexible, low thermal coefficient or Tg polymers (for example, siloxanes or poly (butyl acrylate)) to photochromic dyes, the dyes are able to switch much more rapidly when in a rigid lens or structure. Some combinations including spirooxazines with siloxane attached polymers switch at near solution-like speeds even when contained in a rigid matrix.

Electrochromic materials change color when a small electric charge is applied. Liquid crystal materials are one type of electrochromic material that provides different polarization states that can be used to block or transmit light.

Hybrid electro-photochromic materials have also been identified. This offers promise for use in ‘smart’ energy-efficient windows and information display panels. Glass treated with electro-photochromic materials can control visible light and solar radiation levels to some degree and are able to regulate illumination levels as well as glare, heat gain, and heat loss. “Smart” windows based on these technologies, for example, can remain transparent while the sun is low in the sky, and gradually darken as it rises and begins to heat interior spaces. Blocking heat using smart windows can help to lower air conditioning costs and thereby help to reduce air pollution associated with burning fossil fuels. As the sun sets and exterior light levels decrease, the window gradually returns to transparency. An intriguing advantage of the new material is the ability to “override” its natural response when used as a conventional electrochromic device.

Problems that prevent large-scale fabrication of photochromic and electrochromic devices include the lack of adequate reversibility (switching back and forth from transparency to a colored state), instability and poor durability of the material over the long term, and high cost. Thus, it can be seen that methods for improving the manufacturability and use of these materials would be beneficial for a number of applications.

### SUMMARY

The presently disclosed subject matter can, among other features, advance the optical arts by providing materials having variable opacity. According to an aspect of the presently disclosed subject matter, an optical element can include a substrate material having a pattern of cavities formed on a surface; a substantially transparent seal layer disposed against the surface; and a photochromic or electrochromic material sealed by the substantially transparent seal layer within the cavities formed in the surface.

Among advantages and characteristics offered by embodiments of the present invention are less costly fabrication of photochromic and electrochromic devices, improved durability and performance of photochromic and electrochromic apparatus, and improved uniformity of the deposited electrochromic and photochromic materials. Embodiments of the present invention also allow combined photochromic or electrochromic behavior and polarization for use in a range of devices.

These and other aspects, features and advantages of the present invention will be more clearly understood and appreciated from a review of the following detailed description of exemplary embodiments and appended claims, and by reference to the accompanying drawings.

### BRIEF DESCRIPTION OF THE DRAWINGS

FIG. 1 is a side view of optical elements that provide variable light transmission according to an embodiment of the present invention.

FIG. 2 is a partial perspective view that shows a small portion of an optical element with variable opacity formed to have cavities arranged in a pattern of cells.

FIG. 3 is a side view of an alternate embodiment that combines polarization and photochromic features in an optical element.

FIG. 4A is a side view of an alternate embodiment that combines a wire grid polarizer with a liquid crystal material.

FIG. 4B is a side view of an alternate embodiment that combines a wire grid polarizer with a liquid crystal material and uses a patterned array.

FIG. 5 shows a perspective view of eyeglasses with a lens that utilizes the optical element of FIG. 4A.

FIG. 6 is a side view of an alternate embodiment that provides a controlled signal across two wire grid polarizers.

FIG. 7 is a side view of an alternate embodiment that shows a heater for an electrochromic material.

### DETAILED DESCRIPTION OF EXEMPLARY EMBODIMENTS

Figures shown and described herein are provided in order to illustrate key principles of operation and fabrication for an optical apparatus according to various embodiments and a number of these figures are not drawn with intent to show actual size or scale. Some exaggeration may be necessary in order to emphasize basic structural relationships or principles of operation. Where they are used, the terms “first”, “second”, and so on, do not necessarily denote any ordinal or priority relation, but may be simply used to more clearly distinguish one element from another.

In the context of the present disclosure, a material is considered substantially transparent if it transmits more than 70% of incident light. Both photochromic and electrochromic materials are considered to be “variable opacity” materials, with the same material changing opacity and, optionally, color, when suitable energy is applied. This category includes various types of dyes, liquid crystal materials, and other fluidic materials. Materials are considered to be fluidic if they exhibit some amount of flow, with viscosity generally less than 250 Pa-s.

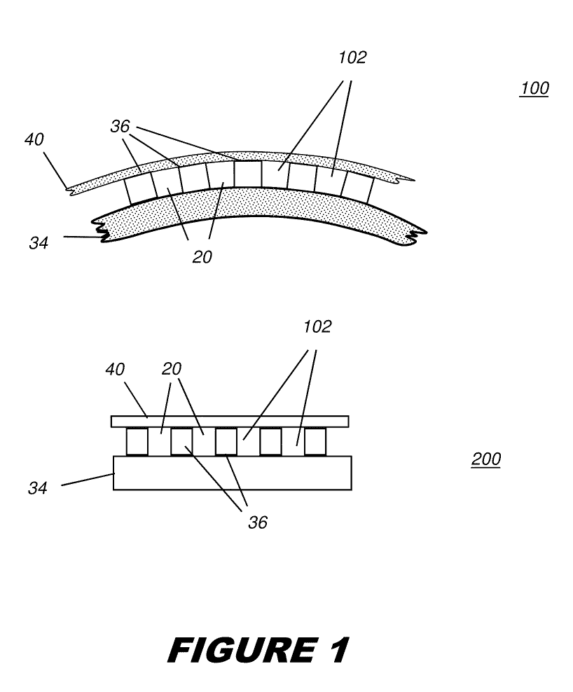

FIG. 1 shows a curved optical element 100 and a flat optical element 200 that provide variable optical transmission according to an embodiment of the present invention. Sandwiched between a substrate 34 and a layer 40 are elongated structures 36 that are formed from substantially transparent materials, but could alternately be formed of non-transparent materials, with spacing between them. A variable opacity material 102 is also sandwiched between substrate 34 and layer 40 and may also be entrapped in recesses or other cavities 20 between structures 36. The variable opacity material 102 may be photochromic or electrochromic material and may be fluidic.

Structures 36 are elongated in the configuration shown in FIG. 1, but could have some other shape. The arrangement of structures 36 can be on a scale that provides a grid, such as a wire grid polarizer. Alternately, structures 36 could have some other spacing that precludes polarization. Structures 36 are the same material as substrate 34 and layer 40 in one embodiment. For example, structures 36 can be formed by molding or treating the surface of a substrate to form cavities 20. Alternately, structures 36 can be of a different material, deposited on substrate 34 or applied as part of layer 40.

With the embodiment of FIG. 1, optical elements 100 or 200 are capable of holding a photochromic dye or electrochromic material in a “suspension” like state, allowing the photochromic dyes to react to the photonic radiation much more rapidly, or allowing the electrochromic material to respond to a voltage that is applied. This allows these materials to be less costly than those conventionally used for smart windows and other variable opacity applications.

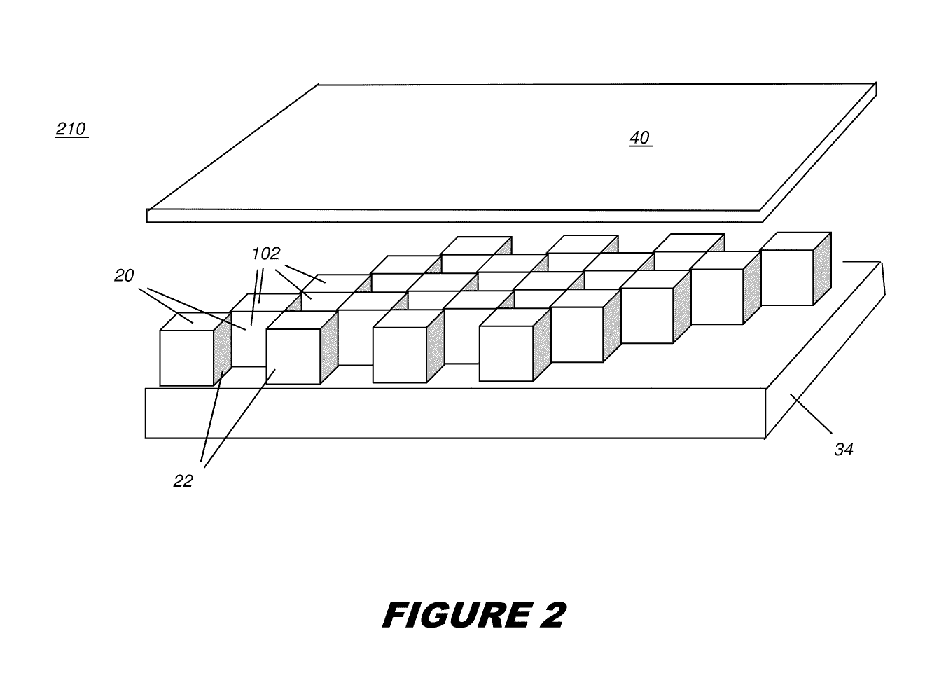

The partial perspective of FIG. 2 shows a small portion of an optical element 210 with variable opacity formed to have cavities 20 arranged in a pattern of cells 22. Variable opacity material 102 is encased within cells 22 and sealed by layer 40. Cells 22 are cube-shaped structures in one embodiment, but cell 22 can be formed in other shapes and patterns to hold the photochromic or electrochromic material, such as honeycomb, dimples, conical, or other suitable shapes. In an alternate embodiment, substrate 34 is itself patterned, such as by being molded or etched, to have an arrangement of cells 22. Cells 22 can be of any suitable size or length. The materials used for forming the walls of cells 22 can be conductive or non-conductive, or alternating conductive and non-conductive. Substrate 34 can be substantially flat or can have visible curvature, such as for eyewear, canopies, domes, or curved windows, for example.

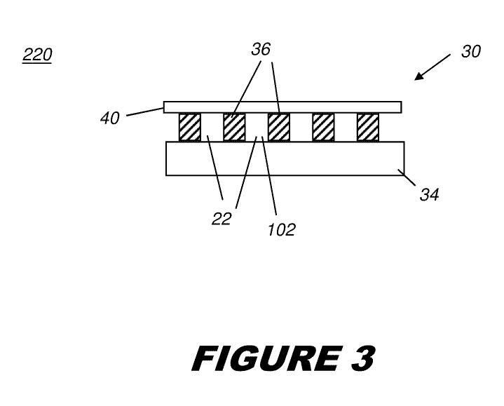

The side view of FIG. 3 shows an alternate embodiment of an optical element 220 in which polarization and photochromic functions are combined. Elongated structures 36 form a grid, such as a wire grid polarizer 30. Photochromic material is deposited in cavities 22 between and, optionally, over structures 36 which may be of aluminum or other material. This arrangement can be used to provide a polarized, photochromic lens. In an alternate embodiment, either substrate 34 or layer 40 is formed from a polarizing material. In yet another alternate embodiment, variable opacity liquidic material 102 is both photochromic and polarizing.

In embodiments of the present invention, it is not necessary to use metallic wire grids or polarizing materials to create the grooves or grid. It may be desired to have a non polarizing product which is photochromic, in which case the grid may be made of an array of structures formed or deposited on a substrate which can hold the photochromic dye. The grid can form a wire grid polarizer or may be some other non-polarizing grid arrangement.

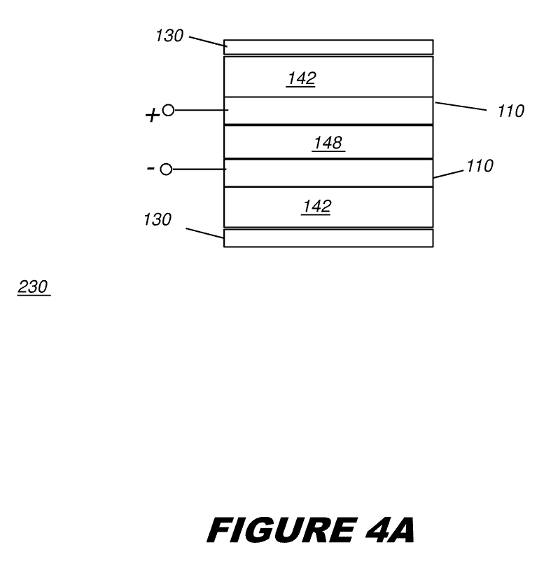

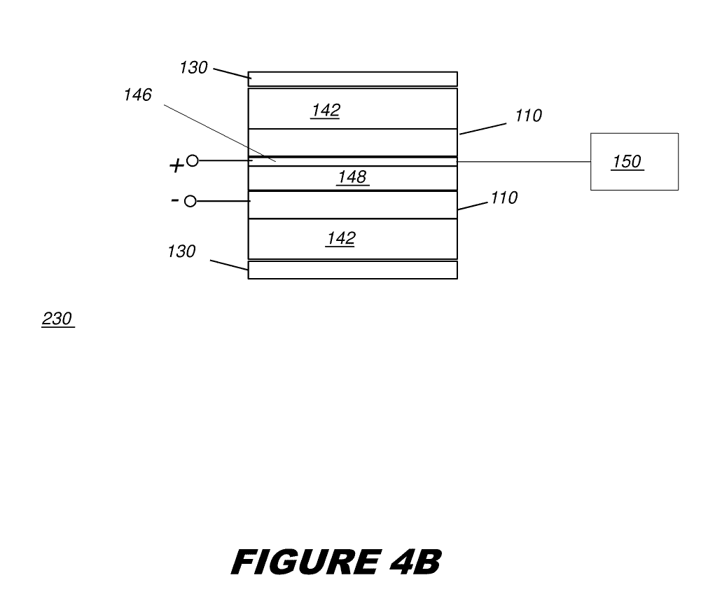

The side view of FIG. 4A shows an alternate embodiment of an optical element 230 that has an electrochromic liquid crystal (LC) material 148 as an interstitial material sandwiched between two wire grid polarizers 110, each formed on a transparent substrate. The wire grid polarizers 110 are positioned to form a suitable gap, such as a couple of microns, between them. Here, wire grid polarizers 110 provide the substrate material and act as both electrodes and alignment layers to provide a variable opacity shutter device. Each polarizer 110 is formed on one side of a glass substrate 142. One or more optional compensation layers 130 are added to adjust the polarization behavior. Applying a variable voltage between polarizers 110 changes the polarization alignment of liquid crystal material 148 to provide variable opacity. In one embodiment, polarizers 110 are oriented orthogonally with respect to each other. In an alternate embodiment, as shown in FIG. 4B, one of the two polarizers acts as an electrode and a patterned array 146 is added between the two polarizers 110, with a second electrode connected to the patterned array. Patterned array 146 can be formed of switching elements such as thin film transistors. An optional control logic processor 150 is in signal communication with patterned array 146 for actuating the switching elements to form a pattern.

In an alternate embodiment, an antireflective layer and one or more insulating layers are also provided. An optional color filter can also be provided with the FIG. 4A or 4B embodiments.

One of the wire grid polarizers may be treated with a layer of non reflecting material such as carbon to act as an anti-reflective surface reducing or eliminating unwanted reflections from the surface. In an alternate embodiment, another type of polarizer can be used in place of wire grid polarizer 110.

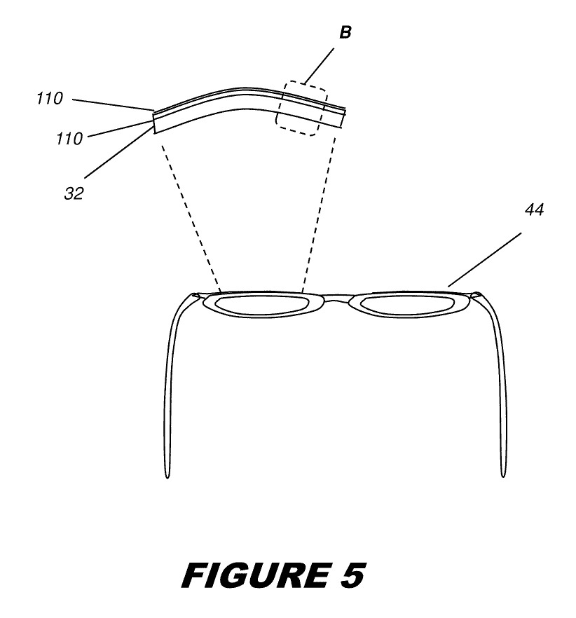

FIG. 5 shows a perspective view of eyeglasses 44 with a lens 32 that utilizes optical element 230 of FIG. 4A.

Embodiments of the present invention can be used in devices such as high-performance sunglasses and protective eyewear, such as in products that need to be photo-polarized, such as: a filter that becomes polarized when exposed to light energy. An advantage of wire grid polarizers relates to their ability to conduct heat and prevent hot spots from occurring in sun glasses and other eyewear. Since LC devices operate better in warm conditions and are more sluggishly in cold, embodiment of the present invention may make it is possible to utilize the wire grids to incorporate an internal heating element to generate a small amount of heat to prevent the liquid crystal materials from freezing or performing poorly in cold temperatures. This can be provided using materials that generate heat when used as electrodes, for example.

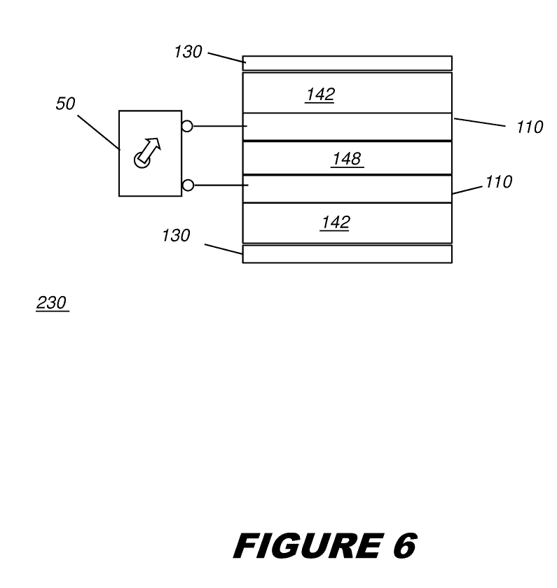

FIG. 6 shows an alternate embodiment in which a variable voltage can be applied between wire grid polarizers 110 in the embodiment of FIG. 4A. A control 50 can be provided for manual operation or for automatic operation. In one embodiment, control 50 responds to a photovoltaic-generated signal that causes changes in opacity or color of liquid crystal material 148 to be effected. In one embodiment, optical element 230 has multiple controls 50, spaced at intervals to allow localized control of element dimming.

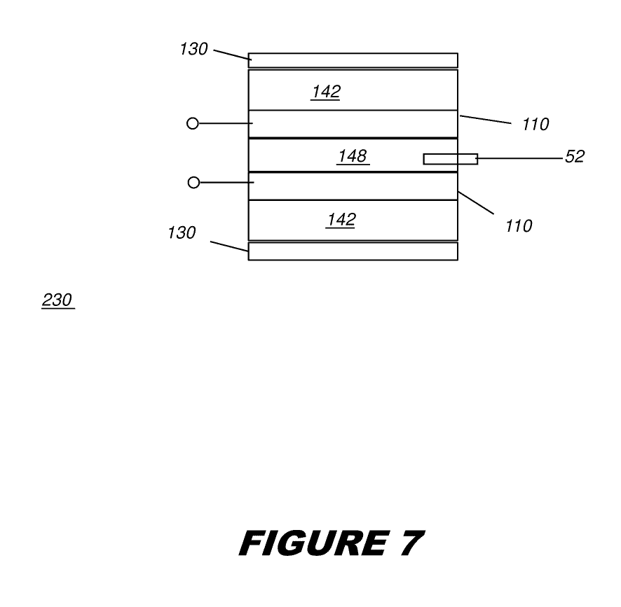

FIG. 7 shows an alternate embodiment that employs a heater element 52 to heat the LC material 148 to improve its response under cold conditions. This can be combined with the approach shown in FIG. 6, wherein adjustable voltage is provided to heater element 52.

One or more sensors may be provided for sensing ambient temperature and other variables. Additionally, sensors can be provided for detecting laser light or bright light sources or determining light spectral content, and directing this information to a remote computer (not shown) or to a microprocessor on the optical element 230 itself, thereby forming a control loop. A battery or other power source may be included as part eyeglasses or other protective eyewear using optical element 230. An electrode can be controlled by a microprocessor to adjust voltage bias along the elongated structures that provide the polarizer. In another embodiment, separate electrodes are provided for different zones or sections of optical element 230 so that electrochromic response can be modified over just a portion of the surface.

### Materials and Fabrication

Embodiments of the present invention enable more precise design and fabrication of photochromic and electrochromic products by allowing the deposition of photochromic dyes exactly where desired, in the quantities needed to provide an intended effect. The designer can create recesses or pockets at any desired position, interval or pattern in or on the substrate to optimize the spacing and orientation of the cavities in which photochromic dye molecules are deposited. In addition, embodiments of the present invention permit the depth of the recesses to be controlled, allowing more or less dye to be deposited in the recess/pocket if desired. When sealed, the cavities act like miniature thermos bottles, holding the dye in a loose, suspension like state. This control is a very desirable feature not possible with existing methods or manufacturing techniques.

Substrates and cover layers can be formed from many different materials including glass, plastic, or polycarbonate. Substrate shapes may be flat or curved.

There are many types of photochromic materials in various classes: triarylmethanes, stilbenes, azastilbenes, nitrones, fulgides, spiropyrans, naphthopyrans, spiro-oxazines, quinones among others. Embodiments of the present invention allow different amounts of these materials to be deposited in cavities on the substrate or between structures of a wire grid polarizer.

Electrochromic materials change color when a small electric charge is applied. Liquid crystal materials are one type of electrochromic material that provides different polarization states that can be used to block or transmit light by providing varying states of opacity according to the applied energy.

Hybrid electro-photochromic materials have also been identified. It has been shown that with an electrode consisting of thin transparent films of nickel hydroxide [Ni(OH)2] and titanium dioxide [TiO2] layered and formed on glass, adding titanium dioxide film to the nickel hydroxide film, the combination has potential use as either a photochromic device or an electrochromic device, or both. Electrochemical reactions driven by light in the ultraviolet spectrum produce photochromic behavior. When light strikes the titanium-nickel sandwich, electrons from the Ni(OH)2 layer flow to the TiO2 film. The NiII(OH)2 oxidizes into a form of higher nickel (NiIII and NiIV) oxides. As it does, what was a transparent film gradually darkens to shades of gray and black. When the light is blocked, the reaction reverses itself. Full coloration of the prototype device from transparency to its darkest state requires about 10 minutes. This offers promise for use in ‘smart’ energy-efficient windows and information display panels. Glass treated in this way can control visible light and solar radiation levels to some degree and are able to regulate illumination levels as well as glare, heat gain, and heat loss. “Smart” windows based on these technologies, for example, can remain transparent while the sun is low in the sky, and gradually darken as it rises and begins to heat interior spaces. Blocking heat in this way can help to lower air conditioning costs and thereby help to reduce air pollution associated with burning fossil fuels. As the sun sets and exterior light levels decrease, the window gradually returns to transparency. An intriguing advantage of the new material is the ability to “override” its natural response when used as a conventional electrochromic device.

Cavities can be formed using a number of methods, including etching, molding, grinding, coarse rubbing, or machining, for example. The pattern of structures used for a wire grid polarizer can be formed in any of a number of conventional ways or can be formed using deposition by nano-printing, for example.

A range of coatings can alternately be applied to the surface of layer 40, such as an anti-reflection coating, for example.

Other possible applications of materials providing both photochromic and electrochromic properties include large-scale photoelectrochromic display panels for computers and other electronic equipment, “smart” windows and rearview mirrors for cars and trucks, photochromic lenses for sunglasses, and new types of light detectors, optical switches and light intensity meters. Another application is as a low-cost memory device for optical computers. Further, the ability to store information in a binary form—transparent or dark, representing zeros and ones—or to encode data as levels of gray, make electro-photochromic materials possible candidates for display-panel and memory-device applications.

Still other possible applications of materials providing both photochromic and electrochromic properties include large-scale photoelectrochromic display panels for computers and other electronic equipment, “smart” windows and rearview mirrors for cars and trucks, photochromic lenses for sunglasses, and new types of light detectors, optical switches and light intensity meters. Another application is as a low-cost memory device for optical computers. Further, the ability to store information in a binary form—transparent or dark, representing zeros and ones—or to encode data as levels of gray, make electro-photochromic materials possible candidates for display-panel and memory-device applications.

Wire grid polarizers can be formed from a range of materials, including aluminum and ferro-electric materials, for example. Wire grid polarizer fabrication is known to those skilled in the art and is described, for example, in U.S. Pat. No. 6,108,131, entitled “Polarizer apparatus for producing a generally polarized beam of light” to Hansen et al. and U.S. Pat. No. 6,122,103, entitled “Broadband wire grid polarizer for the visible spectrum” to Perkins et al., which describe improved-performance wire grid polarizer devices designed for the visible spectrum. All patent references described above are hereby incorporated in their entirety by reference.

It should be noted that wire grids could be formed as wire grid polarizers for the visible spectrum, or for other parts of the electromagnetic spectrum. Other arrangements of wire grids can alternately be used for wire grids 110 in FIGS. 4A-7.

The invention has been described in detail with particular reference to certain exemplary embodiments thereof, but it will be understood that variations and modifications can be effected within the scope of the invention as described above, and as noted in the appended claims, by a person of ordinary skill in the art without departing from the scope of the invention. The invention is defined by the claims and equivalents thereof.

1. An optical element comprising:
a substrate material having a pattern of cavities formed on a surface;
a substantially transparent seal layer disposed against the surface; and
a photochromic or electrochromic material sealed by the substantially transparent seal layer within the cavities formed in the surface.

2. The optical element of claim 1 wherein the pattern of cavities is formed by a wire grid polarizer.

3. The optical element of claim 1 further comprising a non-conductive cooling fluid sealed within the cavities.

4. The optical element of claim 1 further comprising an aerogel material sealed within the cavities.

5. The optical element of claim 1 wherein the cavities are formed by molding or are embossed.

6. The optical element of claim 1 wherein the photochromic or electrochromic material is fluidic.

7. The optical element of claim 1 wherein the cavities are within cells that are formed on the surface of the substrate material.

8. The optical element of claim 1 wherein the photochromic or electrochromic material is also a polarizing material.

9. The optical element of claim 1 wherein the substrate material is flat.

10. An optical element comprising first and second wire grid polarizers spaced apart from each other to form opposite surfaces and an interstitial material sealed between and in direct contact with the first and second wire grid polarizers.

11. The optical element of claim 10 wherein the interstitial material comprises a photochromic or electrochromic material.

12. The optical element of claim 11 wherein the interstitial material further comprises an aerogel material.

13. The optical element of claim 10 wherein the first wire grid polarizer comprises a carbon layer.

14. The optical element of claim 10 further comprising a heater disposed to heat the interstitial material.

15. An optical element comprising a substrate material, one or more wire grids formed on one or more surfaces of the optical element, at least a first electrode that connects to the one or more of wire grids, and a fluidic electrochromic material sealed against the one or more wire grids.

16. The optical element of claim 15 further comprising a patterned array and a second electrode that connects to the patterned array of switching elements.

17. The optical element of claim 15 further comprising a second electrode that connects to a second wire grid.

18. The optical element of claim 16 further comprising a control logic processor in signal communication with the patterned array.

19. The optical element of claim 15 wherein the one or more wire grids are formed from a ferro-electric material.

20. The optical element of claim 15 wherein at least one of the wire grids is a wire grid polarizer.
